(19) United States
(12) Patent Application Publication
(10) Pub. No.: US 2017/0044000 A1
(43) Pub. Date: Feb. 16, 2017

(54) HORSE SNAFFLE BIT HAVING TWO SIDE RINGS AND A SHACKLE

(71) Applicant: HERM. SPRENGER GMBH & CO. KG, ISERLOHN (DE)

(72) Inventors: VALENTIN VOELLMECKE, ISERLOHN (DE); HEINZ BAUMANN, ISERLOHN (DE)

(73) Assignee: HERM. SPRENGER GMBH & CO. KG, ISERLOHN (DE)

(21) Appl. No.: 15/307,371

(22) PCT Filed: Apr. 1, 2015
(86) PCT No.: PCT/EP2015/057202

§ 371 Date: Oct. 28, 2016

(30) Foreign Application Priority Data
Apr. 30, 2014 (DE) 10 2014 208 262.5
May 16, 2014 (DE) 10 2014 209 361.9

(51) Int. Cl. B68B 1/06

(52) U.S. Cl. CPC B68B 1/06

(57) ABSTRACT

A horse's snaffle bit includes two side rings and a shackle arranged between the two side rings. The shackle has at least one joint and two side portions each of which has an end portion. Each joint is provided as an eyelet which interlocks with a clearance at the end portion of each of the two side portions. Each of the two side portions further has an end with an annular bore formed therein which is arranged distant from the joint to receive one of the two side rings therein. Each of the two side portions has a lip region arranged immediately adjacent to the annular bore, a transitional region, and a projection region. The transitional region provides for a continuous and smooth transition from a substantially round cross section of the lip portion to a substantially non-round cross section of the projection region.

### CROSS REFERENCE TO PRIOR APPLICATIONS

This application is a U.S. National Phase application under 35 U.S.C. §371 of International Application No. PCT/EP2015/057202, filed on Apr. 1, 2015 and which claims benefit to German Patent Application No. 10 2014 208 262.5 filed on Apr. 30, 2014 and to German Patent Application No. 10 2014 209 361.9 filed on May 16, 2014. The International Application was published in German on Nov. 5, 2015 as WO 2015/165686 A1 under PCT Article 21(2).

### FIELD

The present invention relates to a horse's snaffle bit.

### BACKGROUND

Single-jointed and double-jointed horse's snaffle bits have previously been described in EP 17 959 A1. The cross section of the side portions tapers increasingly inwards, towards the at least one joint, starting from the area around the annular bore. Each of the joints is formed as eyelets interlocking with a clearance at the end portions of the side portions or of the central portion.

A single-jointed and a double-jointed horse's snaffle bit has previously been described in EP 1 140 693 B3. EP 1 140 693 B3 describes that the cross section of the side portions tapers continuously and steadily from their end portions towards the at least one joint. The side portions have substantially round cross sections between the annular bore and the eyelet. The eyelet axes of the eyelets of the two side portions are situated at an angle of 45°±20° to the reference plane. The central portion of the double-jointed horse's snaffle bit is formed to be as short as possible and olive-shaped.

A horse's snaffle bit having side portions with non-round cross-sectional shapes is described in DE 10 2011 114 147 A1. The side portions have a projection forming an edge. The edge starts in the immediate vicinity of the annular bore of a side portion and ends directly in front of the eyelet of the side portion. This edge points towards the rear during practical use in the horse's mouth. The cross section of the side portion tapers distinctly starting from the end portion towards the at least one joint. The cross-sectional surface area in the vicinity of the annular bore is more than twice the size of that in the immediate vicinity of the eyelet. The eyelet has an external dimension that is approximately twice the size of the adjacent area of the side portion. The bit is intended to be inserted into a horse's mouth in two different orientations. The side portions are correspondingly marked with “soft” and “sharp” for this purpose.

The shackle turns within the horse's mouth when pulling the reins. An originally uppermost point of the shackle moves forward. A displacement of the shackle towards the rear within the horse's mouth also occurs when at least one rain is pulled.

As used herein, “front” means towards the tip of the horse's mouth, “rear” means towards the neck of the horse, “up” means away from the top of the tongue in an upward direction, and “down” means from the top of the tongue downwards. The terms “left” and “right” are used herein relative to the position of a rider. The term “central” as used herein relates to the center of the bit, or to the center of the shackle.

The bit width is defined as follows: The horse's snaffle bit is supported on one of the rings and hangs free in a downward direction, the shackle is substantially vertical, the other ring is located underneath. Any clearance in the annular bore and the joints is used up. The shortest distance between the two rings is now measured. This distance is slightly greater than the distance of the two axes of the annular bores.

In contrast to rigid shackles, single-jointed horse's snaffle bits are advantageous in that, when the reins are pulled on one side, the respectively operated side portion is able at first to move, in particular, to turn, to a certain extent until the clearance in the joint is used up and the other side portion is also moved along. The clearance is more than 20°; it may actually be more than 30°, and in particular more than 45°. In the case of double-jointed horse's snaffle bits, twice the clearance must be overcome, i.e., the clearance of the two joints. Single-jointed, and in particular double-jointed bits thus have the opportunity of providing the horse with precise side information.

What is intended is a guidance of the horse if possible only, and if possible, exclusively, by acting on the horse's tongue. A horse's tongue is sensitive. The horse perceives the impressions acting on the tongue in a significantly amplified manner. The guidance of a horse via the tongue is a gentle guidance. It is in particular to be avoided that the shackle can move to the left or to the right during riding. As little influence as possible is to be taken on all other portions of the horse's mouth, thus avoiding possible injuries. This means that the tongue is to be given unequivocal and clear impulses through the rein aids. The impressions on the tongue are to be perceived unilaterally on the horse's tongue if the reins are pulled unilaterally. The horse is thus supposed to distinguish unilateral rein aids from each other and also from a bilateral rein aid.

### SUMMARY

An aspect of the present invention to develop a horse's snaffle bit so that the horse is able to clearly distinguish a left-hand, a right-hand, and a bilateral rein aid from each other by its tongue, and that the tongue correspondingly receives clear guidance information via the at least one moved side portion. The central portion is thereby supposed to be as passive as possible; in the case of rein aids, it is supposed to provide the horse with no impressions, if possible. Even if the central portion may possibly move in the case of a rein aid, it should do it in such a way that the horse feels this movement as little as possible. The central portion is supposed to roll as smoothly as possible. The horse is thus to be enabled to pay attention to the movements of the at least one side portion, but to disregard the central portion.

An aspect of the present invention is to provide a bit which is as soft as possible while at the same time providing the horse with unequivocal and clear guidance information, with the right and the left being clearly distinguishable, and the guidance information acting on the tongue.

In an embodiment, the present invention provides a horse's snaffle bit which includes two side rings and a shackle arranged between the two side rings. The shackle comprises at least one joint, two side portions each of which comprise an end portion, or two side portions each of which comprise an end portion and a central portion comprising two end portions which are arranged opposite to each other. Each of the at least one joint is provided as an eyelet which is configured to interlock with a clearance at the end portion of each of the two side portions or the end portion of each of the two side portions and at each of the end portions of the central portion. Each of the two side portions further comprises an end comprising an annular bore formed therein which is arranged distant from the at least one joint. The annular bore is configured so that each of the two side portions is freely movable to receive one of the two side rings therein. Each of the annular bores comprise an axis which lies in a reference plane when the shackle is extended. A distance between the two side rings defines a bit width. Starting from a respective annular bore and in a direction towards the at least one joint, each of the two side portions further comprises, in the order set forth, a lip region arranged immediately adjacent to the annular bore, the lip region comprising a substantially round cross section, a transitional region, and a projection region comprising a substantially non-round cross section and a controlling edge which points towards a front. The controlling edge has a length which is 6% to 30% of the bit width. The transitional region is configured to provide for a continuous and smooth transition from the substantially round cross section of the lip portion to the substantially non-round cross section of the projection region.

### BRIEF DESCRIPTION OF THE DRAWINGS

The present invention is described in greater detail below on the basis of embodiments and of the drawings in which:

FIG. 1 shows a top view of a double-jointed bit where the paper plane forms the reference plane and where upwards is towards the front;

FIG. 2 shows a view of the bit according to FIG. 1 with the viewing direction II in FIG. 1 where the bit is not fully extended and sagging slightly;

FIG. 3 shows a section taken along the section line III-III in FIG. 1;

FIG. 4 shows a section taken along the section line IV-IV in FIG. 1;

FIG. 5 shows a top view of a double-jointed bit as in FIG. 1 where the paper plane is once again the reference plane;

FIG. 6 shows a side view of the bit with the viewing direction II in FIG. 5, but not in the extended position and in an orientation in which the paper area substantially matches the surface of the horse's tongue;

FIG. 7 shows a perspective view of one of the two symmetrically constructionally identical side portions of the bit according to FIG. 5;

FIG. 8 shows a section taken along the section line VIII-VIII in FIG. 5;

FIG. 9 shows a section taken along the section line IX-IX in FIG. 5;

FIG. 10 shows a perspective view of the side portion according to FIG. 6 in another viewing direction;

FIG. 11 shows an illustration of a second exemplary embodiment of the single-jointed bit in a view similar to FIG. 2;

FIG. 12 shows a section taken along the section line XII-XII in FIG. 11;

FIG. 13 shows a section taken along the section line XIII-XIII in FIG. 11;

FIG. 14 shows a section taken along the section line XIV-XIV in FIG. 11;

FIG. 15 shows an illustration of a second exemplary embodiment for the double-jointed bit in a side view similar to FIG. 6; and

FIG. 16 shows a view in the viewing direction XVI-XVI according to FIG. 15, however, with a dangling central portion and without the second side portion.

### DETAILED DESCRIPTION

In the horse's snaffle bit of the present invention, the side portions in the transitional region and in the projection region are deliberately configured with a non-round cross section. They clearly have a non-round cross section.

The cross-sectional dimension of the projection region in the projection direction can, for example, be at least 10%, in particular at least 20% larger than the corresponding dimension in the lip region. The cross-sectional dimension of the projection region in the projection direction can, for example, be at least 10%, in particular at least 20% larger than in the direction perpendicular thereto, i.e., in the direction transverse to the projection direction. The cross-sectional dimension of the projection region transverse to the projection direction can, for example, be at least 10%, in particular at least 20% smaller than the corresponding dimension in the lip region. In a top view, i.e., in the viewing direction onto the reference plane, the side portion does not, for example, become thicker from the outside towards the inside; in particular, it becomes thinner by at least 5%. In a side view, i.e., in the viewing direction parallel to the reference plane, the side portion can, for example, become thicker from the outside towards the inside by at least 5%.

The cross section in the lip region is substantially round. No influence is exerted on the lips when the shackle is turned in the horse's mouth. The lips are treated gently. The deviation from an ideal circle is less than 10%, in particular less than 5%, for example, even less than 3%. The action of a rein aid only has an effect on the tongue located between the lips and the location of the projection region. The central portion, or the joint of the single-jointed bit, is in this case supposed to lie on the center of the tongue, if possible. It is there supposed to rest as passively as possible so that the action of the respective side portion is clearly perceivable on the tongue on the lift-hand side and the right-hand side and the horse is enabled to clearly distinguish between the left-hand side and the right-hand side.

The projection direction is directed towards the front. This means that in the horse's mouth, the controlling edge is located on the side of the reference plane that points forward. Based on the direction “forward”, the controlling edge can, for example, be situated in an angle range of 15° downward to 45° upward.

The controlling edge is orientated so that, when a rein is pulled, i.e., when the shackle turns, the edge is increasingly tilted relative to the surface of the tongue. The horse perceives a stronger impression of the controlling edge on the tongue as the pull on the reins becomes stronger. Initially, i.e., without a rein aid, a lower contact surface rests on the top of the horse's tongue. The controlling edge substantially points forward. When the reins are pulled, the controlling edge moves increasingly into the tongue. The lower contact surface thereby moves into an increasingly oblique position and, at the rear, is increasingly lifted up from the tongue. The controlling edge can, for example, be orientated in an angle range of about 85°±30°, in particular ±15° and, for example, ±5° towards the front relative to the reference plane.

Due to the cross section, which changes starting from the end portions of the side portions towards the inside, the bit has relatively large surfaces for resting on the tongue. They have a positive effect on the horse without, however, creating a strong, linear contact. The bit according to the present invention rests on the surface of the tongue over a rather large surface area.

The present invention has an effect in the side portions. Compared to EP 1 140 693 B3, the rings, and in particularly the optionally provided central portion, remain unchanged. In the lip region, the bit according to the present invention is configured in the same way as described in EP 1 140 693 B3. The bit according to the present invention may be described in such a way that, based on the bit described in EP 1 140 693 B3, additional material is added for forming the projection region and the transitional region; there, the bit according to the present invention has larger cross-sectional dimensions and a larger circumference, respectively, than the bit described in EP 1 140 693 B3 at the same location. The bit according to the present invention is clearly non-round in the projection region, whereas the bit described in EP 1 140 693 B3 is substantially round at the corresponding location. Round and non-round in each case relates to the cross-sectional surface area. The bit according to the present invention has an approximately egg-shaped cross section in the projection region with the tip forming the guiding edge.

As regards the side portions, the lip region can, for example, have a length of 2 to 15% of the bit width. The cross-sectional dimension of the projection region, which is measured parallel to the reference plane, can, for example, be at least 5% smaller than the corresponding cross-sectional dimension of the lip region. The controlling edge pointing towards the front can, for example, have a length of 8 to 17% of the bit width, in particular of 10 to 15% of the bit width. The external dimension of the eyelet can, for example, be greater by at most 10%, in particular by at most 5%, than the greatest cross-sectional dimension of the adjacent projection region. The eyelets thus transition more continuously into the adjacent area of the side portion. The external dimension of the eyelets is greater by at most 25%, in particular by at most 15%, than the cross-sectional dimension of the immediately adjacent region measured in the same orientation. In the bit described in DE 10 2011 114 147 A1, the external dimensions of the eyelets is, in contrast, more than twice the size of the cross-sectional dimension of the immediately adjacent region measured in the same orientation; the eyelets thus protrude to a significant extent and seem like a separate part similar to a spoon. The cross-sectional dimension of the projection region, which is measured transversely to the reference plane, can, for example, be at least 5% larger than the corresponding cross-sectional dimension of the lip region. The cross section of the lip region, which is substantially round, can, for example, have a deviation of the largest diameter from the smallest diameter of at most 20%, in particular at most 10%. One slightly curved contact surface can, for example, be provided on each of the two sides of the controlling edge, i.e., the lower contact surface and an upper contact surface. At least the lower contact surface has a radius of curvature of greater than 30 mm, as seen in the cross sectional area. The lower contact surface, which comes in contact with the horse's tongue and rests thereon, can, for example, contact the horse's tongue over a length that is at least 10% greater, for example, at least 20% greater, as seen in the cross sectional area, than the corresponding area in the bit described in EP 1 140 693 B3, or a round cross-sectional shape. The radius of curvature of the lower contact surface is at least twice the size of that in the bit described in EP 1 140 693 B3. The controlling edge can, for example, come as close as possible to an eyelet axis of the eyelet of the side portion, the distance being at most 15% of the bit width, in particular at most 10% of the bit width. The projection region is supposed to come as close as possible to the eyelet but not impede the free movement of the jointed connection.

In contrast to the bit described in EP 1 140 693 B3, where, particularly in the case of the double-jointed bit, it is the respectively pulled eyelet that transmits the essential left-hand or right-hand guidance information to the horse's tongue, the present invention provides that it is the respective controlling edge in the case of the bit, optionally supported by the lower contact surface adjacent thereto in the circumferential direction. The eyelet is integrated into the side portion so that it does not protrude substantially over it; it is therefore considerably less important for the guidance function than is the bit described in EP 1 140 693 B3.

In the bit according to the present invention, the controlling edges of the two side portions can, for example, be situated at the same angle relative to the reference plane.

The bit according to the present invention is either single-jointed or double-jointed. The single-jointed configuration differs from the double-jointed configuration. In the double-jointed configuration, the side portions can, for example, be constructionally identical in mirror symmetry to a central plane. The central plane in that case passes through the geometric center of the central portion and is perpendicular to the reference plane and to a longitudinal axis of the shackle. The two side portions are considerably different in the single-jointed configuration. The controlling edge can, for example, protrude from one side portion in a direction which is substantially parallel to the eyelet axis of the associated eyelet, or in any case extends in the same plane. In contrast, in the other side portion, the eyelet axis substantially extends transversely to the direction in which the controlling edge protrudes.

The axis of the one eyelet is always perpendicular to the axis of the other eyelet engaging it in an eyelet connection.

It can be advantageous in the double-jointed bit to have the axis lines of the eyelets of the side portions extend at an angle of 45°±20° to the reference plane, in particular at an angle of 45°±10° to the reference plane. In the single-jointed bit, it can in contrast be advantageous if the axis of the eyelet of the one side portion extends parallel to the reference plane and the axis of the eyelet of the other side portion lies in a plane that extends perpendicular to the reference plane and is orientated in the longitudinal direction of the shackle.

It can be advantageous if the projection region also has a counter-projection. The latter is disposed diametrically to the projection forming the controlling edge. Such a counter-projection can, for example, be provided in the single-jointed bit.

The maximum clearance of each joint can, for example, be up to 2 mm in the longitudinal direction of the shackle and transverse thereto. It may even amount to up to 3 mm.

The bits according to the present invention have a greater contact surface of the bit on the tongue. This is the case in the event the reins are not pulled. As the rein aid increases, the contact surface becomes smaller; the pressure of the controlling edge, however, becomes higher. The bit thickness can, for example, be 10 to 20% of the bit width, in particular 13 to 17%, for example, 15%.

The side portions can, for example, have an arcuate curvature as is described in the prior art. The radius of curvature located in a plane perpendicular to the reference plane and in the longitudinal direction of the shackle has a dimension of 8-20, for example, 10 to 16 cm.

The rings are also referred to as snaffle rings. They are formed in accordance with the prior art. They may have any shape and also have additional regions of any kind.

Seen in the direction of the longitudinal axis, the controlling edge can, for example, have a radius of between 1 and 5 mm, in particular 2 to 4 mm, for example, 3 mm.

Those side portions in which the eyelet axis is at an angle of greater than 30° to the reference plane can, for example, have the form of the head of a dolphin or beluga whale, as seen in a side view. This means that, in a side view, i.e., in the viewing direction of the reference plane, they are delimited by at least one line similar to an arc of a circle, whose center is outside the silhouette of the side portion. In other words, the silhouette of the side portion has a concave portion and/or at least one point of inflection in a side view. The point of inflection is situated in the vicinity of a hump; this hump lies in the area of the central end of the side portion.

Other advantages and features of the present invention become apparent from the description of exemplary embodiments, which are to be understood to be non-limiting, as explained below under reference to the drawings.

For the individual exemplary embodiments, identical technical items are designated with the same reference numbers. This also applies to dimensions, planes, directions etc. If not all reference numbers and all dimensions, directions and planes are drawn into an individual Figure, this does not mean that these indications do not exist. The other drawings should much rather be referred to.

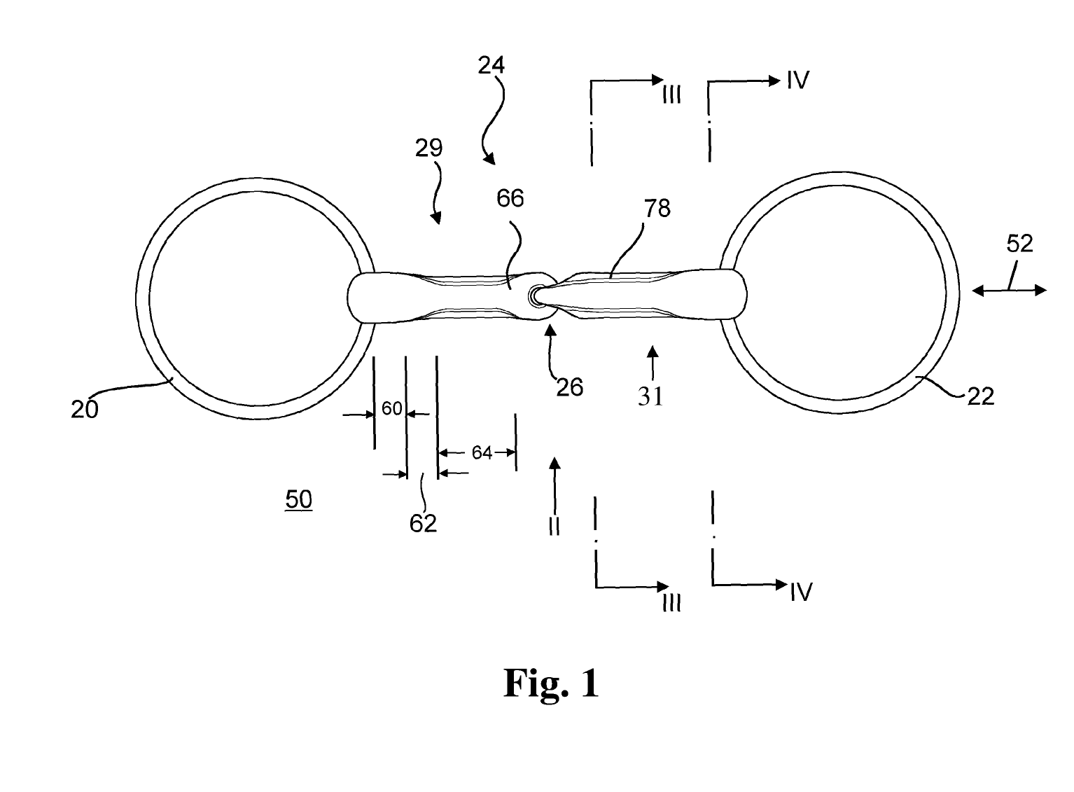

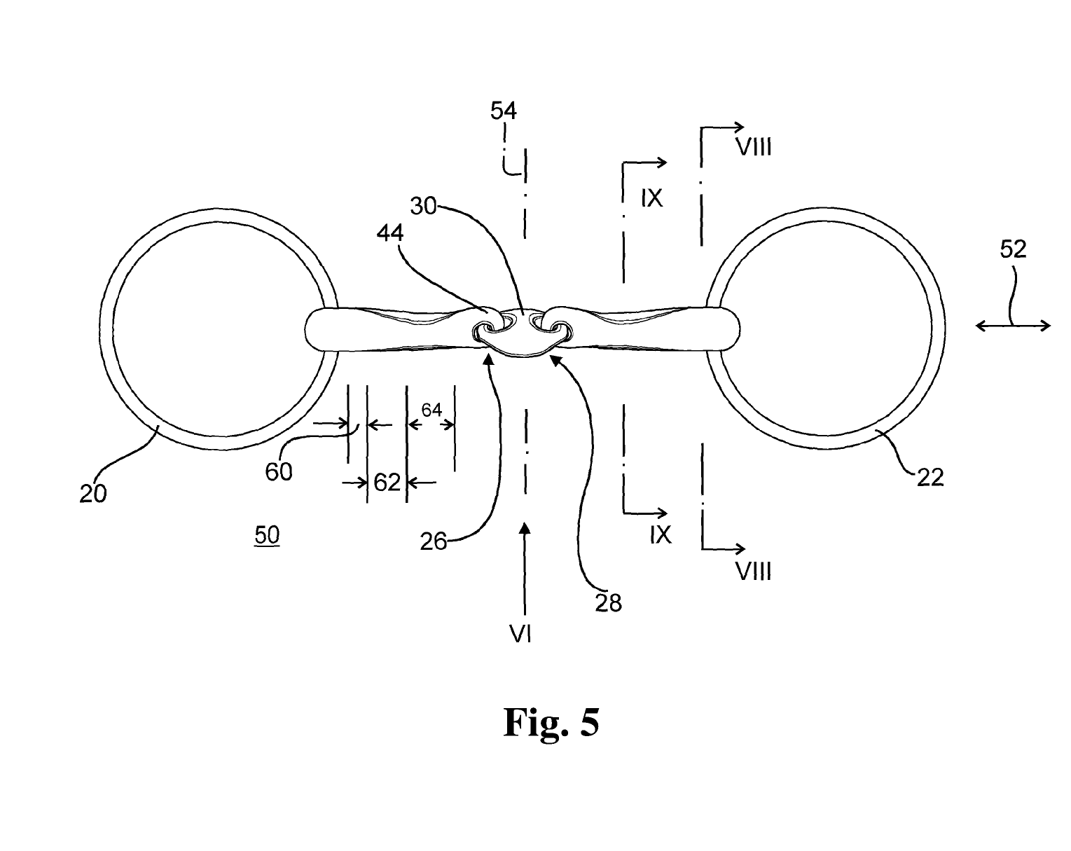

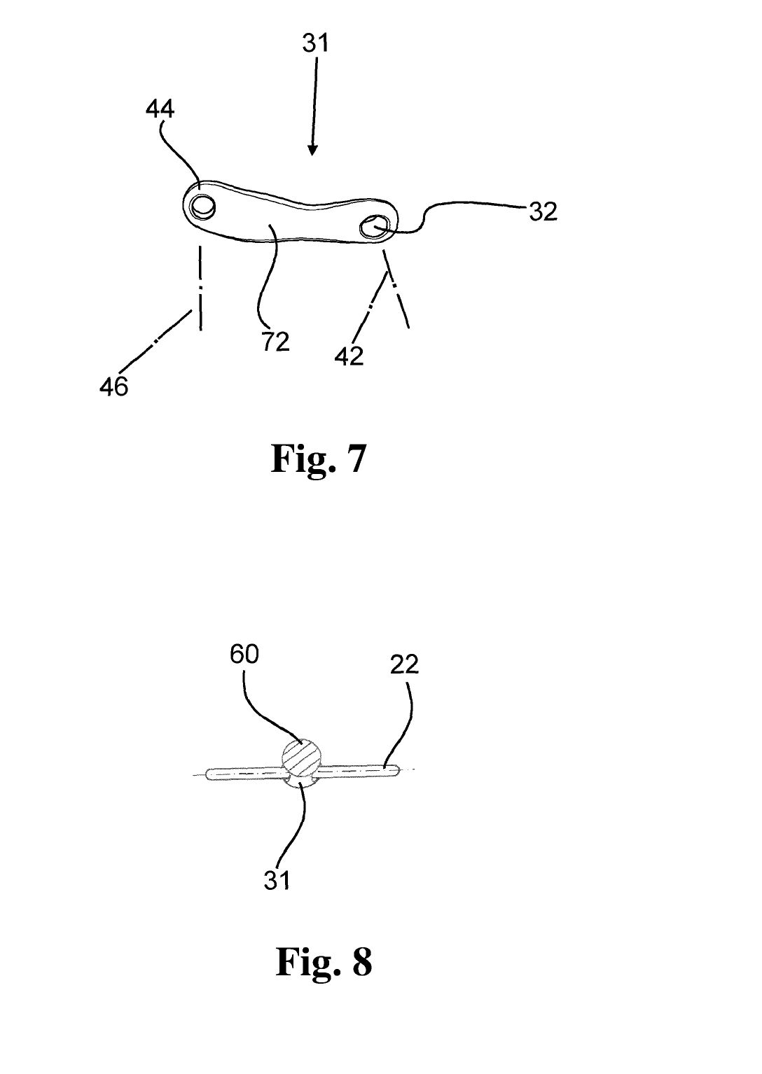

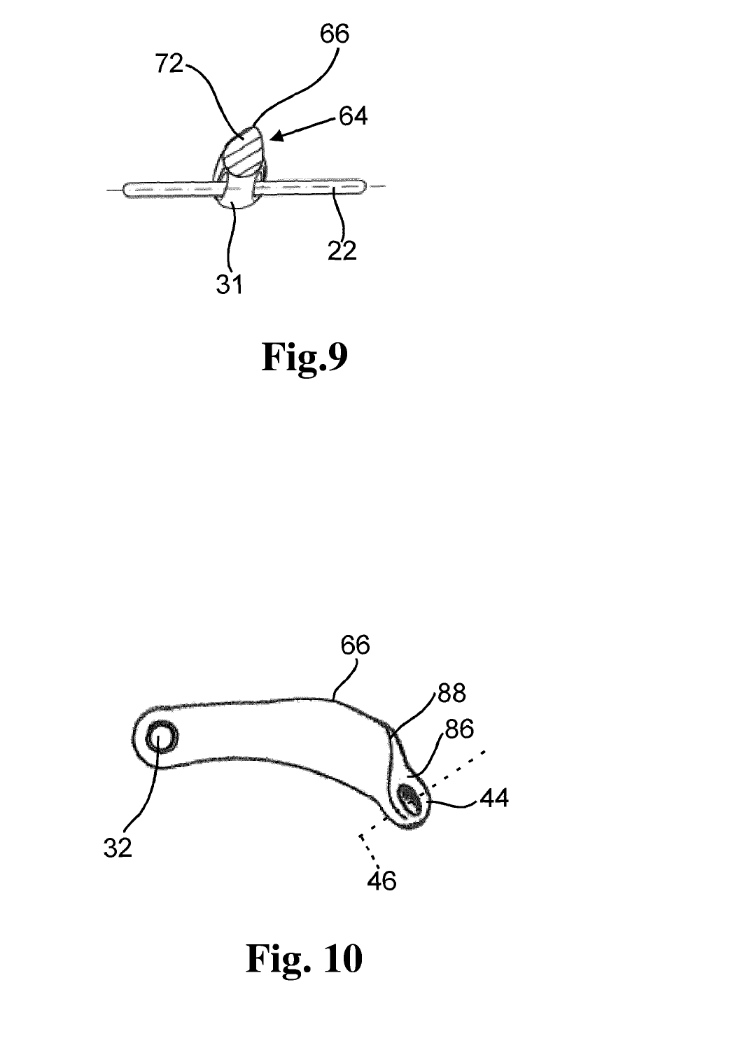

The horse's snaffle bit according to all of the exemplary embodiments has two side rings 20, 22. A shackle 24 is disposed between the two side rings 20, 22. The shackle 24 has two side portions 29, 31. In the case of a single-jointed bit, as in the first exemplary embodiment according to the FIGS. 1 to 4, for example, no further part is added. In a double-jointed bit, as, for example, in the second exemplary embodiment according to the FIGS. 5 to 10, a central portion 30 is located between the two side portions 29, 31. The single-jointed bit has one joint 26, while the double-jointed bit has two joints 26, 28. The joints 26, 28 are each formed as eyelets 44 interlocking with a clearance at the end portions of the side portions 29, 31 or of the central portion 30. Each eyelet 44 has an eyelet axis 46.

Each side portion 29, 31 has an end distant from the center of the shackle 24. One annular bore 32, respectively, for freely movably receiving therein one of the rings 20 or 22 is provided in that distant end of the side portions 29, 31. The annular bore 32 has one axis 42, respectively. If the shackle 24 is extended, the two axes 42 of the annular bores are located in a reference plane 50. The extended state is achieved by the shackle 24 being pulled in a longitudinal direction 52, for example, being freely suspended and dangling down under the influence of gravity. The bit has a central plane 54. It is advantageous particularly for describing the double-jointed bit. It extends transverse to the longitudinal direction 52 and through the geometric center of the shackle 24. This is the geometric center of the central portion 30 in a double-jointed bit. The central plane 54 is perpendicular to the reference plane 50.

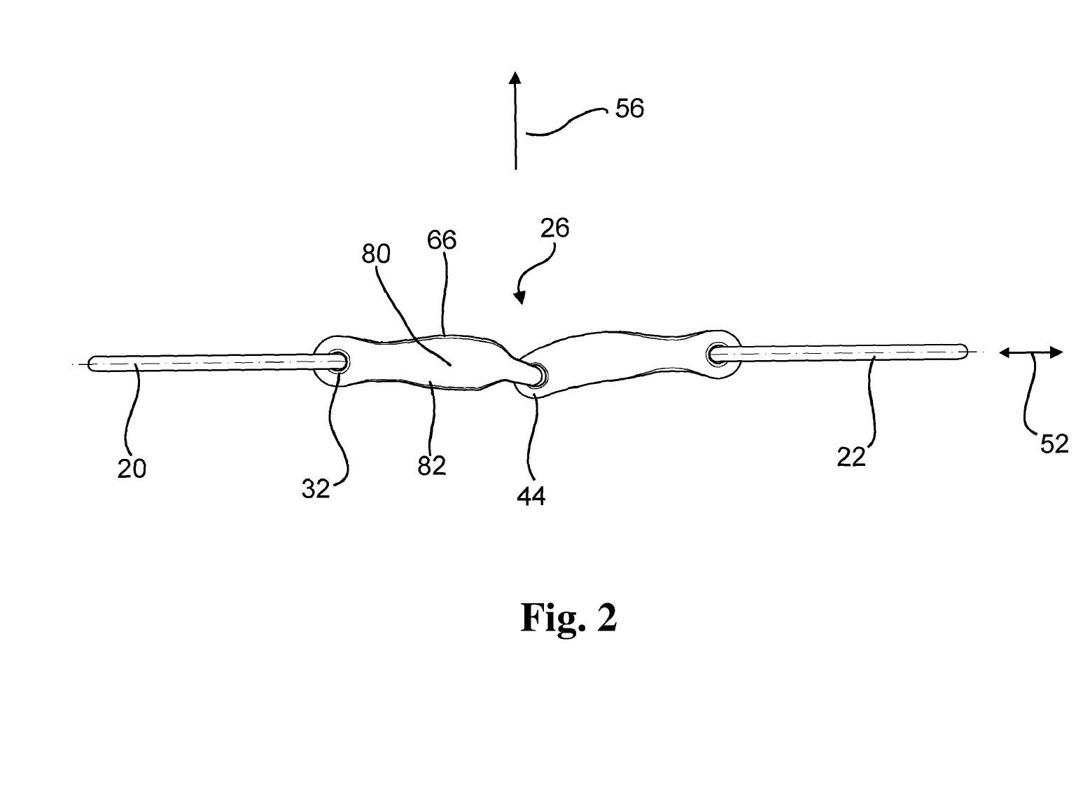

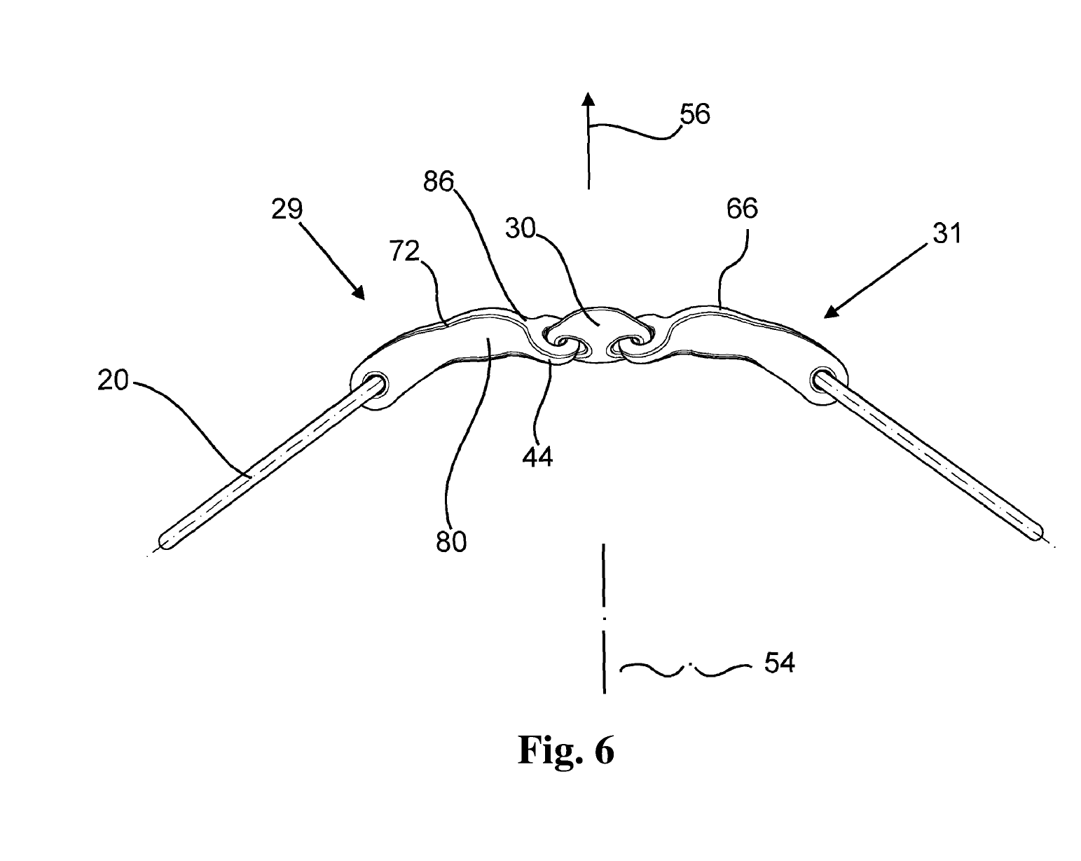

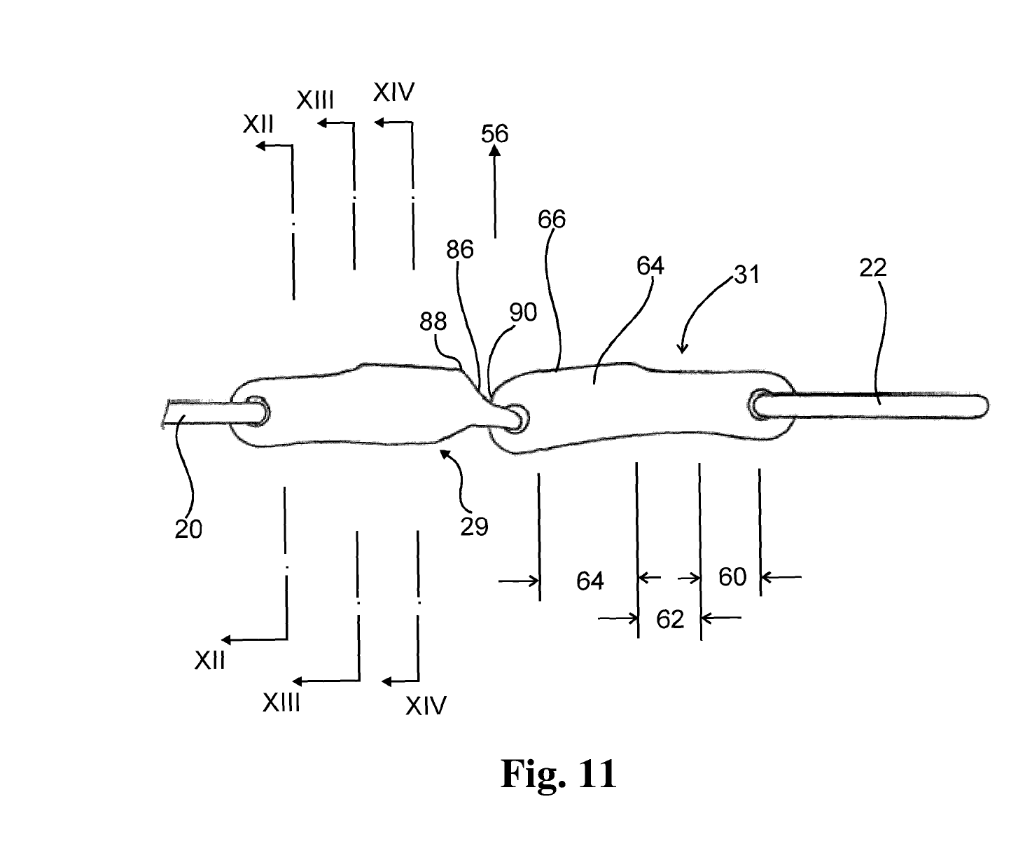

In a top view as shown, for example, in FIG. 1, the reference plane 50 is parallel to the paper plane. In a top view and a side view, e.g., FIG. 2, the central plane 54 is in each case perpendicular to the paper plane. The paper plane coincides with the surface of a horse's tongue (not shown) in FIGS. 2, 6 and 11. These drawings show the approximate position of the bit in space as it is placed on a horse's tongue situated underneath it, represented by the paper plane. The arrow 56 shows the direction towards the front (direction forward). During practical use in the horse's mouth, the shackle 24 is not extended to the extent shown in FIG. 2; it is rather slightly angled as shown in FIG. 6. In contrast to FIG. 6, if the bit is inserted in the horse's mouth, the rings are located too much towards the side portions 29, 31. The rings are almost parallel to each other if the bit is inserted in the horse's mouth, being only slightly oblique and depending on the anatomy.

The double-jointed stirrup is mirror-symmetrical to the central plane 54, which is a mirror plane.

Each individual side portion 29, 31 has three regions, in the order indicated and viewed from the outside towards the center: A lip region 60 that is immediately adjacent to the annular bore 32 has a substantially round cross section, a transitional region 62, and a projection region 64. The projection region 64 forms a controlling edge 66 which generally points towards the front in the horse's mouth. It has a length of 6 to 30% of the bit width, for example, one of 10-25%. The projection region 64 has a substantially non-round cross section. The cross section can, for example, be egg-shaped or oval. The transitional region 62 connects the substantially round lip region 60 and the non-round projection region 64. In the transitional region 62, the substantially round cross-sectional shape transitions, towards the center, into the non-round cross-sectional shape of the projection region 64. The transition is as smooth and assimilated as possible.

A shackle 24 of a horse bit in principle has soft structures. No sharp edges or corners are supposed to be provided; the horse should not experience chafing in any area.

The cross-sectional shape has as slight deviations as possible from the ideal circular shape in the lip region 60. FIGS. 4, 8 and 12 show cross sections. The cross section can, for example, deviate from the ideal circular shape by less than 10%, for example, by less than 5%, and in particular by less than 3%. This means that the largest diameter may only deviate to a corresponding extent from the smallest diameter.

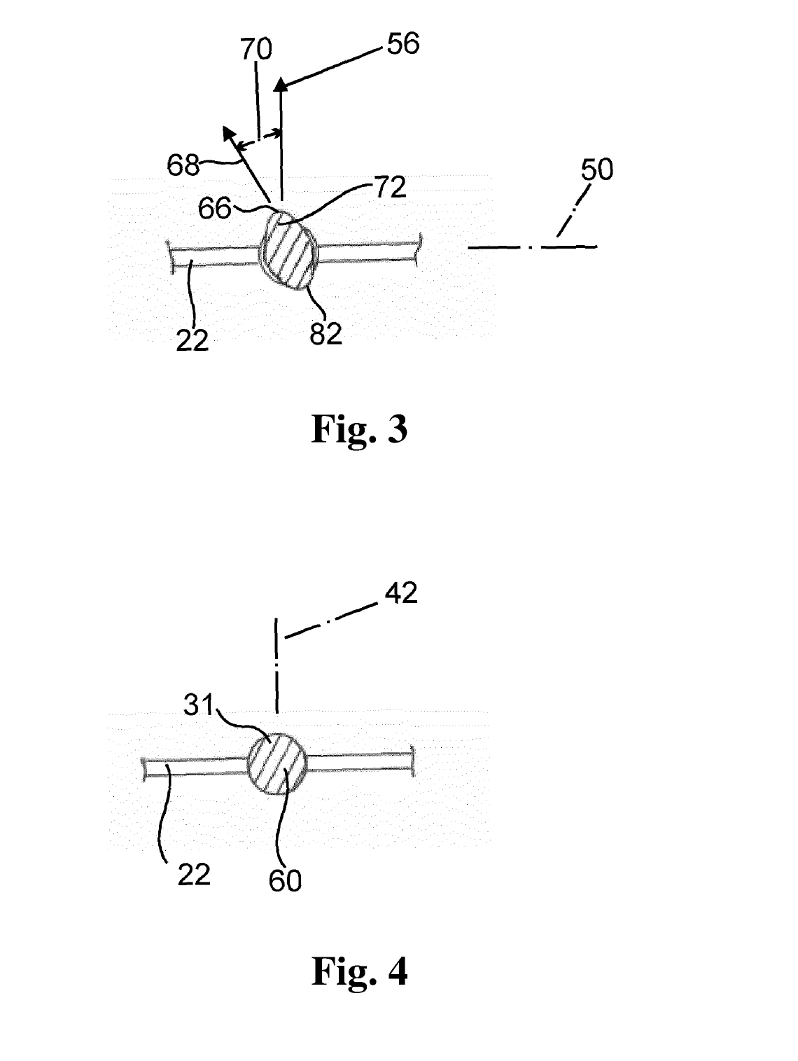

The projection region 64 is orientated. Its controlling edge 66 lies in a defined direction; it is referred to as the projection direction 68. It is situated at an angle 70 measured starting from the direction forward 56 and upwards (see FIGS. 3, 9 and 14). The angle 70 can be in a range of from downwards, i.e., minus 35°, i.e., to the right from the direction forward 56 in FIG. 3, to a value of plus 35°, in particular from minus 25° to plus 15°.

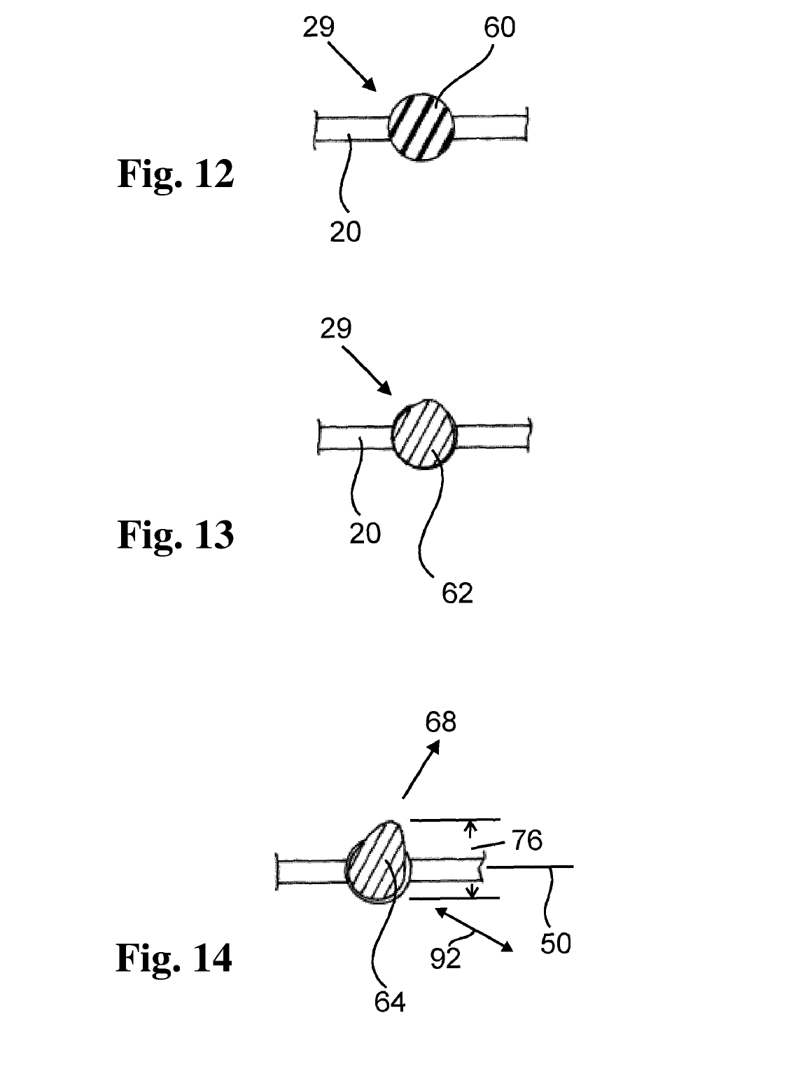

It is apparent from the FIGS. 1, 3, 5, 9 and 14 that, seen in a top view, the side portions 29, 31 basically taper rather than become thicker towards the center. They can, for example, taper by at least 5%. The tapering can be seen in the transition of FIGS. 4 to 3 and FIGS. 8 to 9 and, finally, from FIGS. 12 to 14. In this case, FIG. 13 shows a cross section contained in the transitional region 62. It can be seen that, compared to the cross section according to FIG. 12 contained in the lip region 60, the cross-sectional dimension in the direction of the reference plane 50 has become smaller. This is continued in the cross section according to FIG. 14 contained in the projection region 64. These three drawings gradually show the formation of a projection 72. It is slowly formed in the projection direction 68 from the round cross section according to FIG. 12 towards the non-round cross section according to FIG. 14. This can also be demonstrated in the two other examples. The cross sections in the FIGS. 13 and 14 would each be substantially round in the prior art. They would be located within the circle located outside the hatched portion in FIGS. 13 and 14. The material added in the projection direction 68 to the initially round cross section is recognizable.

As the above-mentioned drawings show, the cross-sectional dimension, viewed in the transverse direction 92, i.e., measured in the projection direction 68, is clearly larger in FIG. 14 than in FIG. 12. This is also true for a viewing direction parallel to the reference plane 50. Viewed in this direction, the height dimension 76 is greater than the corresponding dimension in cross section according to FIG. 13. In a side view, the side portions 29, 31 therefore can, for example, become increasingly thicker towards the center, in particular by at least 10%. The transverse direction 92 extends perpendicularly to the projection direction 68; both extend perpendicularly to the longitudinal direction 52.

Viewed in the circumferential direction, the controlling edge 66 is adjoined on the one side by a lower contact surface 78 and on the other side by an upper contact surface 80. The lower contact surface 78 is intended for coming into contact with the tongue of a horse. It has relatively large radii of curvature when seen in cross section. The radii of curvature can, for example, be at least 50% greater than in the lip region 60. The radii of curvature can, for example, be greater than the diameters of the lip region 60. The lower contact surface 73 has virtually has no curvature in the longitudinal direction 52; it extends in an almost straight line. This creates an overall large surface area. It is at least 50% greater than the surface area in a round cross section acting on a horse's tongue. Typical radii of curvature for the lower contact surface 78, viewed in a cross-sectional plane, are in the range of 18±5 mm. Typical radii of curvature for the controlling edge 66 are in the range of 3±2 mm.

In the single-jointed bits, a counter-projection 82 can, for example, also be provided in the projection region 64. Counter-projection 82 projects in the opposite direction to the projection 72. The angle 70 at which a tip of this counter-projection 82 is situated may deviate by ±15% from the projection direction 68. The projection 72 can, for example, project at least 2 mm, in particular at least 3 mm, in the projection direction 68 from a round cross section with the diameter of the smallest cross-sectional dimension of the projection region 64. The counter-projection 82 can, for example, be formed to be smaller or less pronounced; it projects by e.g., 50% of the dimension of the projection 72. The counter-projection 82 is configured to be rounder than the projection 72 in the area of its controlling edge 66. The radii of curvature can, for example, be more than twice the radius of curvature of the controlling edge 66.

The central portion 30 is formed in accordance with the prior art. It has eyelets, referred to as central portion eyelets 84. Seen in the central plane 54, the central portion 30 has as circular a cross-sectional surface area as possible. It is supposed to deviate from an ideal circle by at most 20%, in particular by at most 10%, with the smallest diameter in a cross section again being compared with the largest diameter.

In the two embodiments of the double-jointed bit, the eyelet axes 46 of the eyelets 44 are at an angle 70 of 45°±20°, in particular 45°±10°, to the reference plane 50.

The side portion 29, 31 is generally delimited by convex surfaces. In the region of the eyelet 44 and in the direction towards the controlling edge 66, however, there can, for example, be a concave surface 86. Such a concave surface 86 may also be provided on the averted rear side of the eyelet 44 (see FIG. 2). In the single-jointed bit according to FIGS. 1 to 4 and FIGS. 11 to 14, it is only one side portion 29 that has the at least one concave surface 86. In the other side portion 31, in which the eyelet axis 46 extends transverse to the projection direction 68, the eyelet 34 transitions into the projection 72 on a convex line 90. The edge of the eyelet is orientated in the same direction as the projection 72 so that the boundary line of the eyelet 44 transitions, convexly curved, into the controlling edge 66; this is apparent particularly from the FIGS. 1,2 and 11.

A hump 88 is created (seen in silhouette) in the side portions in which the eyelet axis 46 substantially coincides with the projection direction 68. The line of the silhouette there has a point of inflection. The point of inflection results from the concave surface 86.

In turn, the transitional region 62 also already forms a type of controlling edge 66 which grows increasingly towards the center. It thus has increasingly clearly pronounced contact surfaces that correspond to the contact surfaces 78, 80 in the projection region 64 and come ever closer thereto. The transitional region 62 also contributes to controlling the horse in this regard.

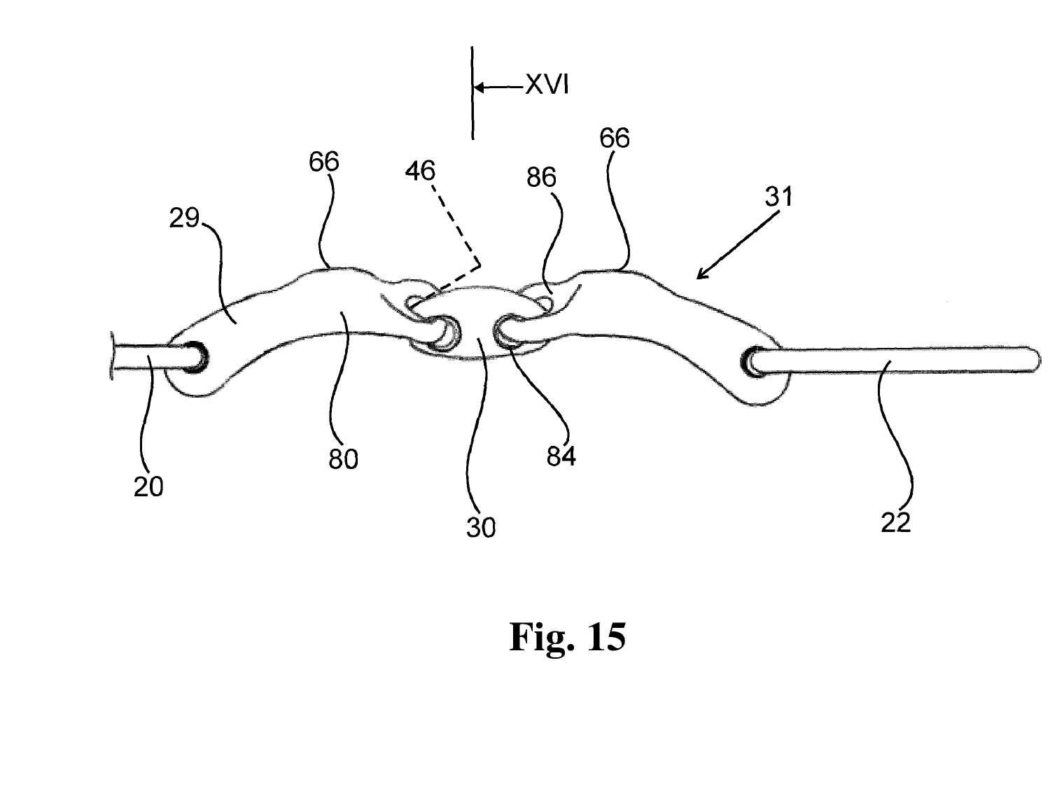

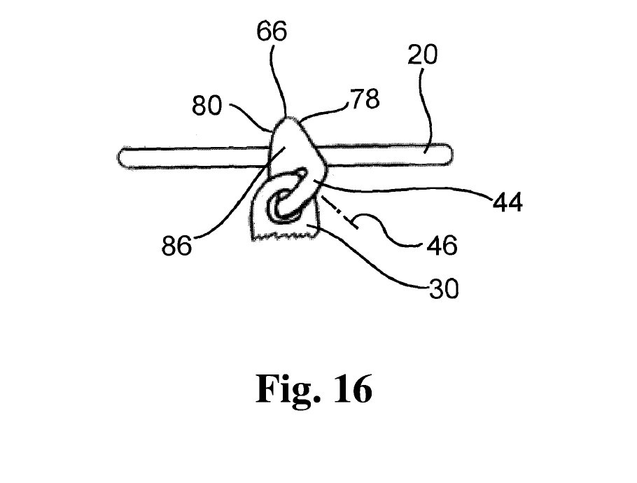

The eyelet axis 46 and the axes of the central portion eyelets 84 each form joint axes about which the respective eyelet joint is able to move. As shown in particular in FIG. 10, a convex line 90 is located opposite a concave surface 86 of the other side portion 29 in the single-jointed bits. In contrast, two concave surfaces 86 are located opposite from each other in the longitudinal direction 52 in the double-jointed bit (see, for example, FIG. 15). The 45° orientation of the eyelet axis 46 is apparent from FIG. 16.

The horse's snaffle bit has two side rings 20, 22 and a shackle 24 disposed between them, which has either two joints 26, 28 and a central portion 30 or one joint 26. The shackle 24 has two side portions. Each side portion 29, 31 has an end with an annular bore 32 for freely movably receiving one of the side rings 20, 22, respectively, which end is distant from the at least one joint 26, 28. Each side portion 29, 31 has the following regions, in the order indicated: A lip region 60 that is immediately adjacent to the annular bore 32 which has a substantially round cross section; a transitional region 62; a projection region 64 that forms a substantially non-round cross section; and, a controlling edge 66 that points forward and has a length of 6 to 30% of the bit width or of 10 to 60% of the total length of the side portion 29, 31.

A continuous, smooth transition from the substantially round lip region 60 to the non-round projection region 64 is located in the transitional region 62.

The length of the controlling edge 66 can, for example, be determined as follows: The center line of the side portion 29, 31 is determined. In the process, it is thereby pretended that all the cross section are round (as in the prior art according to EP 1 140 693 B3). In other words, the material additionally added compared with the prior art is not taken into account. The center line extends through the centers of the individual round cross sections. It is generally arcuate and continuous. It is determined substantially by the above-mentioned arcuate curvature. The controlling edge 66 extends at a virtually constant distance thereto.

The end points of the controlling edge 66 are situated at those locations where this distance becomes smaller by more than 20%, in particular by more than 10% and, for example, by more than 5%. The controlling edge 66 can, for example, have a greater distance from this center line than all other points of the surface of the side portion 29, 31.

The present invention is not limited to embodiments described herein; reference should be had to the appended claims.

What is claimed is:

1-14. (canceled)

15. A horse's snaffle bit comprising:
two side rings; and
a shackle arranged between the two side rings, the shackle comprising:
at least one joint,
two side portions each of which comprise an end portion, or two side portions each of which comprise an end portion and a central portion comprising two end portions which are arranged opposite to each other,
wherein,
each of the at least one joint is provided as an eyelet which is configured to interlock with a clearance at the end portion of each of the two side portions or the end portion of each of the two side portions and at each of the end portions of the central portion,
each of the two side portions further comprises an end comprising an annular bore formed therein which is arranged distant from the at least one joint, the annular bore being configured so that each of the two side portions is freely movable to receive one of the two side rings therein,
each of the annular bores comprise an axis which lies in a reference plane when the shackle is extended,
a distance between the two side rings defines a bit width, and
starting from a respective annular bore and in a direction towards the at least one joint, each of the two side portions further comprises, in the order set forth:
a lip region arranged immediately adjacent to the annular bore, the lip region comprising a substantially round cross section;
a transitional region; and
a projection region comprising a substantially non-round cross section and a controlling edge which points towards a front, the controlling edge having a length which is 6% to 30% of the bit width,
wherein, the transitional region is configured to provide for a continuous and smooth transition from the substantially round cross section of the lip portion to the substantially non-round cross section of the projection region.

16. The horse's snaffle bit as recited in claim 15, wherein, measured transversely to the reference plane, a cross-sectional dimension of the substantially non-round cross-section of the projection region is at least 5% larger than a cross-sectional dimension of the substantially round cross section of the lip region.

17. The horse's snaffle bit as recited in claim 15, wherein the substantially round cross section of the lip region comprises a deviation of a largest diameter from a smallest diameter which is at most 15%.

18. The horse's snaffle bit as recited in claim 15, wherein the controlling edge comprises an upper contact surface and a lower contact surface each of which is configured to comprise a slight curve.

19. The horse's snaffle bit as recited in claim 15, wherein,
each eyelet of the two side portions comprises an eyelet axis, and
a distance of the controlling edge to the eyelet axis is at most 15% of the bit width.

20. The horse's snaffle bit as recited in claim 15, wherein the projection region further comprises a counter-projection which comprises a tip, the counter-projection being arranged opposite to the controlling edge.

21. The horse's snaffle as recited in claim 15, wherein, measured in the reference plane, a cross-sectional dimension of the substantially non-round cross section of the projection region is at least 5% smaller than a cross-sectional dimension of the substantially round cross section of the lip region.

22. The horse's snaffle bit as recited in claim 15, wherein at least one of the two side portions comprises at least one of a hump and a concave surface.

23. The horse's snaffle bit as recited in claim 15, wherein the central portion and the two side portions are configured to comprise a mirror symmetry with respect to a central plane.

24. The horse's snaffle as recited in claim 15, wherein,
each eyelet of the two side portions comprises an eyelet axis line, and
the axis lines are configured to extend at an angle of 45°±20° to the reference plane.

25. The horse's snaffle bit as recited in claim 15, wherein,
the central portion comprises two joint bores for forming the two joints, the two joint bores being arranged parallel to each other,
each of the two joint bores comprise a center line, and
the center line of each of the two joint bores is arranged so that a distance of the center lines from each other is less than 2.5 cm.

26. The horse's snaffle bit as recited in claim 15, wherein the central portion is formed so as to comprise a substantially olive-like shape comprising round cross sections in a central plane region.

27. The horse's snaffle bit as recited in claim 15, wherein,
the shackle consists of two side portions and one joint,
one of the two side portions comprises a concave surface, and
the other one of the two side portions comprises a convex line.

28. The horse's snaffle bit as recited in claim 15, wherein the controlling edge is configured to project in a projection direction at an angle of ±45° relative to a forward direction of the horse's snaffle bit.

29. The horse's snaffle bit as recited in claim 15, wherein, measured transversely to the reference plane, a cross-sectional dimension of the substantially non-round cross section of the projection region is at least 10% larger than a cross-sectional dimension of the substantially round cross section of the lip region.

30. The horse's snaffle bit as recited in claim 15, wherein the substantially round cross section of the lip region comprises a deviation of a largest diameter from a smallest diameter of at most 5%.

31. The horse's snaffle bit as recited in claim 15, wherein,
each eyelet of the two side portions comprises an eyelet axis, and
a distance of the controlling edge to the eyelet axis is at most 10% of the bit width.

32. The horse's snaffle as recited in claim 15, wherein,
each eyelet of the two side portions comprises an eyelet axis line, and
the axis lines are configured to extend at an angle of 45°±10° to the reference plane.

33. The horse's snaffle bit as recited in claim 15, wherein the central portion comprises two joint bores for forming the two joints, the two joint bores being arranged parallel to each other.

34. The horse's snaffle bit as recited in claim 15, wherein the controlling edge is configured to project in a projection direction at an angle of ±25° relative to a forward direction of the horse's snaffle bit.

35. The horse's snaffle bit as recited in claim 15, wherein the controlling edge is configured to project in a projection direction at an angle of ±15° relative to a forward direction of the horse's snaffle bit.

36. The horse's snaffle bit as recited in claim 15, wherein the controlling edge is configured to project in a projection direction at an angle of approximately −5° relative to the forward direction of the horse's snaffle bit.
